(19) United States
(12) Patent Application Publication
(10) Pub. No.: US 2015/0055804 A1
(43) Pub. Date: Feb. 26, 2015

(54) Foot-Operated Sound Mixer

(71) Applicant: Jurij Beklemisev, Vilnius (LT)

(72) Inventor: Jurij Beklemisev, Vilnius (LT)

(21) Appl. No.: 13/971,742

(22) Filed: Aug. 20, 2013

(51) Int. Cl. H04R 3/00

(52) U.S. Cl. CPC H04R 3/00
USPC 381/119

(57) ABSTRACT

The present invention provides a foot-operated sound mixer, which, for example, allows a musical performer to adjust personal monitor mix by foot without using hands engaged in playing a musical instrument. The sound mixer of this invention has a housing that has at least one opening. The sound mixer of this invention also comprises an assembly of foot-controlled elements of a user interface comprising scroll wheel assembly and keys that are provided within the housing. The scroll wheel assembly includes a rotatable member positioned within the opening of the housing. The rotatable member is rotatable about an axis that extends within the housing and is laterally movable within the opening relative to the housing. The scroll wheel assembly also includes a movement sensing system that determines when the rotatable member is moved laterally relative to the housing. The keys of said assembly of foot-controlled elements of a user interface are positioned perpendicularly to the scroll wheel rotation axis and at such distance on both sides from the rotatable member so that human foot, when put on the rotatable member, reaches and can activate the keys by tip or toe while the middle part of the foot still touches and remains control of the rotatable member. In present embodiment of the invention said rotatable member is for adjustment of volume level of an audio channel in a monitor mix. In present embodiment of the invention said keys are for audio channel selection.

This application claims the benefit of U.S. Provisional Application No.: 61/691,008 filed Aug. 20, 2012.

### BACKGROUND OF THE INVENTION

The present invention relates in general to live sound reinforcement and more particularly to monitor sound mix and personal monitor mixers.

Personal monitor mixers were originally designed for use in recording studios as more efficient way to deal with monitor sound mix requirements of performers recorded. Indeed, less recording session time is spent achieving and maintaining throughout the recording session the subjective right balance, tone and overall volume of personal monitor mixes of performers recorded if they operate their own dedicated small-sized sound mixing consoles—known as personal monitor mixers—rather than if a sound engineer does it for them.

However, the performers monitor their own sound not only during recording sessions, but during live performance on stage as well. More than that, the importance of monitor sound mix on stage is as important as in the recording studio or even more important, because the subjective right balance, tone and overall volume of a monitor mix is much harder to achieve on stage than in a studio due to higher complexity of live sound monitor systems, poorer sound clarity compromised by venue acoustics, less to no time to soundcheck and human factors of technical crew operating said monitor sound systems. All these factors are resolved at high costs and extra resources—such as hiring and carrying own crew and equipment—or remain unresolved at all. For many top artistes the costs of extra technical and human resources become a burden. The performers “below the top level” are subjected to great deviation between excellent and very bad monitor sound on live shows because of deviation of quality of sound systems as well as technical crews from one show to another. So, there is a great niche for personal monitor mixer application for live show to fix the issues pointed out, but personal monitor mixers available at present applicable on said shows in a very limited way.

As mentioned above, the personal monitor mixers available at present inherited their hand-operated design from serving recording studios. However, recording studio is very different from live theatre because of two key factors. The first key factor is that a recording studio in not a theater in regards to space:
Unlike in a recording studio, in a theatre there is a stage, audience, views, scenery, props, changeovers, video cameras and great attention paid to how everything looks. Hand-operated personal monitor mixers were designed without live stage production issues in mind: they do attract unnecessary attention from the audience, they interfere with scenery and props, they do cause problems during changeovers, they get in the view of cameras. Hand-operated personal mixers simply look bad, because, from the audience point of view, if musicians are tied to some electronic boxes it makes them look like somewhat physically impaired.
On a regular pop and rock concert performers move on stage a lot, therefore the stage is not to be obstructed by extra equipment. However, hand-operated personal monitor mixers are mounted on stands so that hands could reach control surface. If a band equipped with such system, then each performer has such a stand with a personal mixer mounted on, which causes major stage obstruction.
Most important factor is that guitar players, singers and other members of typical rock'n'roll bands perform standing up—not sitting down like musicians in a conventional orchestra. Their hands are engaged in playing musical instruments, such as guitars, and any attempt to operate hand-operated equipment such as personal monitor mixers would inevitably interrupt and compromise their show, which is not the option. It is not the option because of the second key factor, explained below.

The second key factor why a recording studio is different from a theater is that recording session is not a concert in regards of time:
On a regular rock'n'roll show bands do not repeat their set for the same audience—they play it once and there is no chance for correction the other time. There is no “the other time”. Show must go on! So, like already said, if monitor sound mix is no good, stopping playing musical instruments and using hands to operate personal mixers that currently available is just not an option.
Unlike in a recording studio where recording can not happen unless the right balance, tone and overall volume of monitor mixes are achieved for each member of the band recorded and there is no deadline when the recording must start, on a live show there is a deadline therefore bands go on stage and play regardless of the monitor mix balance. This is why live shows still happen even if something is not perfect. No matter if a band has a chance to soundcheck or not—monitor mix can be not perfect or just plain bad. The last resort would be to fix it with a personal monitor mixer of the right kind—allowing for a performer to somehow mix “on the go” without using hands for it, which is something that currently available personal monitor mixers does not allow for the reason explained above.

The bottom line is that currently available personal monitor mixers have no “how-to” that would make them applicable for rock'n'roll type of live shows despite the problems that exist there which such mixers are meant to solve.

### SUMMARY OF THE INVENTION

The present invention relates to a foot-operated sound mixer to adjust sound mix by foot. The device comprises a housing that has at least one opening. The device also comprises an assembly of foot-controlled elements of a user interface within said housing. Said assembly of foot-controlled elements comprises a scroll wheel assembly and the keys that are provided within the housing. The scroll wheel assembly includes a rotatable member positioned within the opening of the housing. The rotatable member is rotatable about an axis that extends within the housing and is laterally movable within the opening relative to the housing. The scroll wheel assembly also includes a movement sensing system that determines when the rotatable member is moved laterally relative to the housing. Said assembly of foot-controlled elements also comprises keys.

The present invention also includes a method of adjusting volume or other parameters of a sound mix by foot using an input device having a housing and an assembly of foot-controlled elements of a user interface of present invention. The method includes the steps of laterally moving by foot the rotatable member relative to a plane in which the member is rotatable and using the keys.

The foot-operated sound mixer according to the present invention makes it easy for performers to adjust monitor sound mix properties, such as volume of instruments in the mix, by foot without having to interrupting playing musical instruments in need to use hands to control mixer of hand-operated design. The foot-operated sound mixer according to the present invention stays on stage floor therefore does not obstruct stage thus allowing free movement of performers on stage. The foot-operated sound mixer according to the present invention also does not compromise the look of live performance because it stays on the floor thus not standing out in front of scenery and attracting audience attention like hand-operated equipment does.

### BRIEF DESCRIPTION OF THE FIGURES

FIG. 1 illustrates a foot-operated sound mixer according to one embodiment of the present invention;

FIG. 2 illustrates the axis of the rotational member and the axis of the keys of the foot-operated sound mixer according to one embodiment of the present invention;

FIG. 3 is the side view of the mixer of present invention that illustrates its operation by foot;

FIG. 4 is an exploded view of the foot-operated sound mixer of the present invention.

### DETAILED DESCRIPTION OF THE FIGURES

As shown in the figures, an exemplary embodiment of the present invention includes a foot-operated sound mixer comprising an assembly of foot-controlled elements of a user interface for adjusting sound mix parameters by foot.

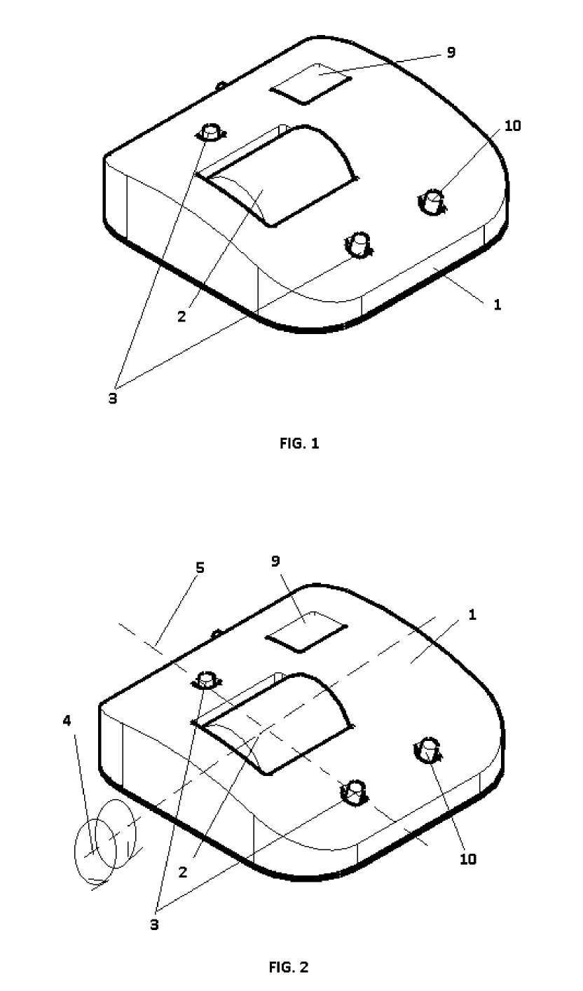

As shown in FIG. 1, one embodiment of the foot-operated sound mixer includes a housing 1 with at least one opening, through which an assembly of foot-controlled elements of a user interface comprising the scroll wheel assembly further comprising a rotational member 2 and keys 3 are accessible for adjustment by human foot.

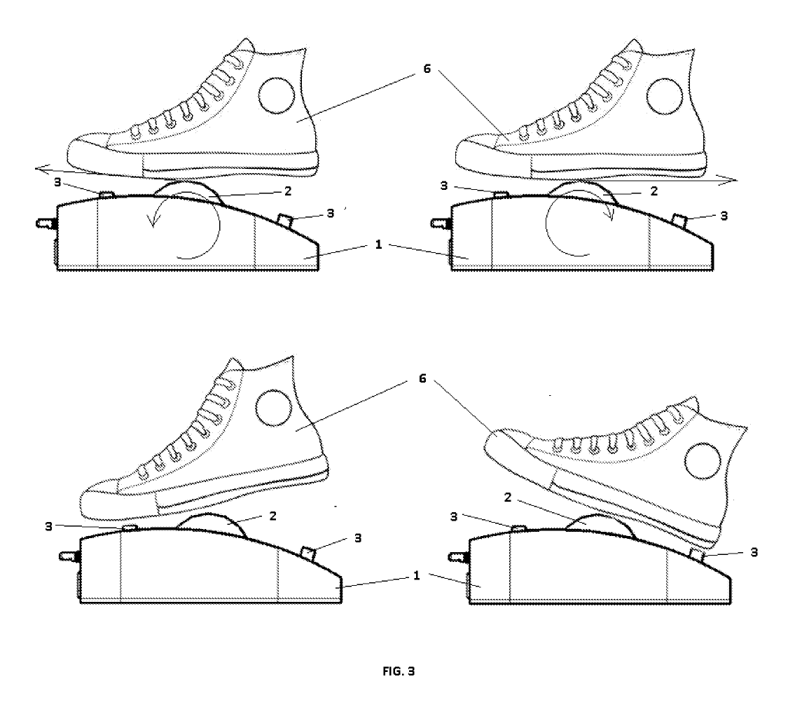

As shown in FIG. 2, the rotatable member 2 of the scroll wheel assembly is rotatable about an axis 4, that extends within the housing 1. The keys 3, which are foot switches in present embodiment of the invention, are positioned on an axis 5 which is perpendicular to the scroll wheel rotation axis, shown on FIG. 2.

As shown in FIG. 3, the rotatable member 2 is laterally movable by foot, which is illustrated as a shoe 6, within the opening relative to the housing. As shown on FIG. 3, the keys 3 are positioned at such distance from the rotatable member 2 on the surface of the housing 1 so that human foot, which is on FIG. 3 illustrated as a shoe 6, when put on the rotatable member 2 reaches and can activate the keys 3 by tip or toe while still touching and remaining control of the rotatable member 2 by the middle part of the foot.

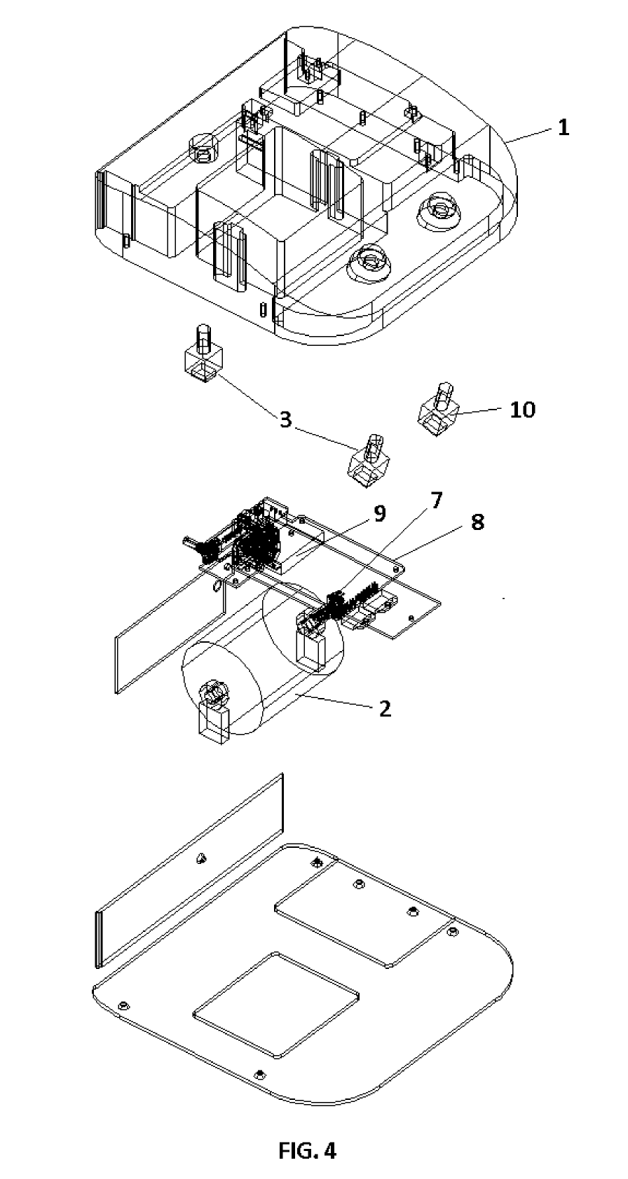

As shown in FIG. 4, the scroll wheel assembly also includes a movement sensing system, which in this embodiment comprising a rotary encoder 7 connected to electronic circuitry 8, that determines when the rotatable member is moved laterally relative to the housing.

In present embodiment of the invention the scroll wheel assembly is for adjustment of the mixer's audio channel volume and the keys 3 are for audio channel selection: one of the keys 3, activated by the tip, is for next channel in the mix and the other one of the keys 3, activated by the toe, is for the previous channel in the mix. Also the present embodiment of the invention includes indicator 9 that indicates currently selected audio channel of the mixer. Also the present embodiment of the invention includes special purpose key 10 that selects the master volume of the mix, which adjusts the overall volume of the mix.

The foot-operated sound mixer may be embodied as stand-alone sound mixing console containing in the same housing a circuitry of a typical sound mixer, or be embodied as a remote control for other sound mix console(s) or digital audio workstations (DAWs), housed in different housing(s).

The foot-operated sound mixer may be resized to adapt to palm of a human hand and keep the same principles of operation described above.

While different embodiments of the invention has been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention which is to be given the full breadth of any and all equivalents thereof.

1. A sound mixer comprising a housing having at least one opening and an assembly of elements of a user interface comprising a scroll wheel assembly and keys as well as electronic circuitry of a typical sound mixer and/or of a remote control for external sound mixer provided within said housing, said scroll wheel assembly including a rotatable member that is positioned within said opening, said rotatable member being rotatable about an axis extending within said housing and being laterally movable within said opening relative to said housing, said keys are positioned within said opening on an axis that is perpendicular to the axis of rotation of the rotatable member, a movement sensing system that determines when said rotatable member is moved laterally relative to the housing.

2. A sound mixer of claim 1 wherein the keys of an assembly of elements of a user interface of claim 1 are positioned at such distance from the rotatable member within the housing so that human foot, when put on the rotatable member reaches and can activate the keys by tip or toe while still touching and remaining control of the rotatable member by the middle part of the foot.

3. A input device comprising an assembly of elements of a user interface comprising a scroll wheel assembly and keys, said scroll wheel assembly including a rotatable member being rotatable about an axis, said keys are positioned on an axis that is perpendicular to the axis of rotation of the rotatable member, a movement sensing system that determines when said rotatable member is rotatable, said keys are positioned at such distance from the rotatable member so that human foot, when put on the rotatable member reaches and can activate the keys by tip or toe while still touching and remaining control of the rotatable member by the middle part of the foot.

4. A method of operating a sound mixing console using the input device comprising an assembly of elements of a user interface comprising a scroll wheel assembly and keys, said scroll wheel assembly including a rotatable member being rotatable about an axis, said keys are positioned on an axis that is perpendicular to the axis of rotation of the rotatable member, a movement sensing system that determines when said rotatable member is rotatable, said keys are positioned at such distance from the rotatable member so that human foot, when put on the rotatable member reaches and can activate the keys by tip or toe while still touching and remaining control of the rotatable member by the middle part of the foot.
